(19) United States
(12) Patent Application Publication
(10) Pub. No.: US 2023/0092726 A1
(43) Pub. Date: Mar. 23, 2023

(54) LEARNING DEVICE, COMMUNICATION DEVICE, UNMANNED VEHICLE, WIRELESS COMMUNICATION SYSTEM, LEARNING METHOD, AND COMPUTER-READABLE STORAGE MEDIUM

(71) Applicant: MITSUBISHI HEAVY INDUSTRIES, LTD., Tokyo (JP)

(72) Inventors: Yujiro KATAOKA, Tokyo (JP); Masayuki ITO, Tokyo (JP); Natsuki MATSUNAMI, Tokyo (JP)

(73) Assignee: MITSUBISHI HEAVY INDUSTRIES, LTD., Tokyo (JP)

(21) Appl. No.: 17/945,549

(22) Filed: Sep. 15, 2022

(30) Foreign Application Priority Data
Sep. 21, 2021 (JP) 2021-153356

(51) Int. Cl. G05D 1/00; G06K 9/62

(52) U.S. Cl. CPC G05D 1/0022; G05D 1/0088; G06K 9/6257

(57) ABSTRACT

A learning device includes a setting unit configured to set a first value for a parameter of a communication device controlled by a computer using a learned model; a reinforcement learning unit configured to allow a learning model to learn; a model extraction unit configured to extract, as a learned model, the learning model; a model evaluation unit configured to determine whether performance of the learned model has reached first requirement; an updating unit configured to update the first value to a second value when the performance is determined to have reached the first requirement; and a model selection unit. The model evaluation unit determines whether the performance of the learned model updated to the second value satisfies second requirement. When the performance of the learned model updated to the second value is determined to satisfy the second requirement, the model selection unit selects that learned model.

### CROSS-REFERENCE TO RELATED APPLICATIONS

The present application claims priority to and incorporates by reference the entire contents of Japanese Patent Application No. 2021-153356 filed in Japan on Sep. 21, 2021.

### FIELD

The present disclosure relates to a learning device, a communication device, an unmanned vehicle, a wireless communication system, a learning method, and a computer-readable storage medium.

### BACKGROUND

Technologies for controlling unmanned aerial vehicles are known. For example, Patent Literature 1 discloses a technique for broadcasting geolocation (geographic location) information from an unmanned aerial vehicle to inform others of the current geolocation of the unmanned aerial vehicle.

### CITATION LIST

### Patent Literature

Patent Literature 1: Japanese Patent No. 6853897

### SUMMARY

### Technical Problem

In an unmanned vehicle system including a plurality of unmanned vehicles, in order to allow the unmanned vehicles to act in cooperation with each other, transmitting information at a high rate is desired because the information on each unmanned vehicle is required in real time, in addition to the policies of other unmanned vehicles obtained by reinforcement learning. For this reason, the unmanned vehicle system forms, for example, a time division multiple access (TDMA) network so that collisions of radio waves transmitted by the unmanned vehicles is prevented, in which slots for transmitting information are set depending on the number of unmanned vehicles in the unmanned vehicle system.

When the unmanned vehicle system includes a large number of unmanned vehicles, such as tens or hundreds of unmanned vehicles, slots to be occupied by individual unmanned vehicles are required, and the overhead for reserving the slots may degrade throughput. Possible ways to resolve the throughput degradation include increasing the wireless bandwidth, increasing transmission power, and improving receiving sensitivity performance. However, increasing the wireless bandwidth may not be allowed to be licensed due to the possibility of interference of communication with other stations, and increasing transmission power leads to increase of the weight of the radio communication device and therefore is disadvantageous for size reduction. As a result, it may be difficult to establish an unmanned vehicle system.

An object of the present disclosure is therefore to provide a learning device, a communication device, an unmanned vehicle, a wireless communication system, a learning method, and a computer-readable storage medium, in which reinforcement learning is applied to the design of wireless communication to establish an unmanned vehicle system appropriately, and performance improvement that is difficult to achieve only with conventional wireless communication designs can be achieved.

### Solution to Problem

A learning device according to one aspect of the present disclosure allows a learned model to be installed in a computer to learn. The learning device includes: a setting unit configured to set a first requirement value for a predetermined parameter of a communication device controlled by the computer using the learned model; a reinforcement learning unit configured to allow a learning model to learn such that a reward given in a predetermined environment is maximized; a model extraction unit configured to extract, as a learned model, the learning model in which a number of learning steps is equal to or greater than a predetermined number; a model evaluation unit configured to determine whether performance of the learned model extracted by the model extraction unit has reached first performance requirement; an updating unit configured to update the first requirement value to a second requirement value different from the first requirement value when the model evaluation unit determines that performance of the learned model has reached the first performance requirement; and a model selection unit configured to select the learned model to be installed in the computer. The model evaluation unit determines whether performance of the learned model updated to the second requirement value satisfies second performance requirement different from the first performance requirement, and when the model evaluation unit determines that performance of the learned model updated to the second requirement value satisfies the second performance requirement, the model selection unit selects the learned model that satisfies the second performance requirement as the learned model to be installed in the computer.

A communication device according to another aspect of the present disclosure is configured to perform communication based on control using the learned model learned by the above-described learning device.

An unmanned vehicle according to still another aspect of the present disclosure includes: a computer in which the learned model learned by the above-described learning device is installed; and a communication device. The computer performs communication through the communication device using the learned model.

A wireless communication system according to yet another aspect of the present disclosure includes a plurality of unmanned vehicles each corresponding to the above-described unmanned vehicle.

A learning method according to yet another aspect of the present disclosure is for allowing a learned model to be installed in a computer to learn. The learning method includes: setting a first requirement value for a predetermined parameter of a communication device controlled by the computer using the learned model; allowing a learning model to learn such that a reward given in a predetermined environment is maximized; extracting, as a learned model, the learning model in which a number of learning steps is equal to or greater than a predetermined number; determining whether performance of the extracted learned model has reached first performance requirement; updating the first requirement value to a second requirement value different from the first requirement value when performance of the learned model is determined to have reached the first performance requirement; determining whether performance of the learned model updated to the second requirement value satisfies second performance requirement different from the first performance requirement; and selecting the learned model that satisfies the second performance requirement as the learned model to be installed in the computer when performance of the learned model updated to the second requirement value is determined to satisfy the second performance requirement.

A non-transitory computer-readable storage medium according to yet another aspect of the present disclosure stores a learning program for allowing a learned model to be installed in a computer to learn using a learning device serving as another computer. The learning program causes the learning device to perform: setting a first requirement value for a predetermined parameter of a communication device controlled by the computer using the learned model; allowing a learning model to learn such that a reward given in a predetermined environment is maximized; extracting, as a learned model, the learning model in which a number of learning steps is equal to or greater than a predetermined number; determining whether performance of the extracted learned model has reached first performance requirement; updating the first requirement value to a second requirement value different from the first requirement value when performance of the learned model is determined to have reached the first performance requirement; determining whether performance of the learned model updated to the second requirement value satisfies second performance requirement different from the first performance requirement; and selecting the learned model that satisfies the second performance requirement as the learned model to be installed in the computer when performance of the learned model updated to the second requirement value is determined to satisfy the second performance requirement.

### Advantageous Effects of Invention

According to the present disclosure, an unmanned vehicle system can be established appropriately, and performance improvement that is difficult to achieve only with conventional wireless communication designs can be achieved.

### BRIEF DESCRIPTION OF DRAWINGS

FIG. 1 is an illustration of learning using a learning model according to embodiments.

FIG. 2 is a block diagram illustrating a configuration example of a learning device according to embodiments.

FIG. 3 is a flowchart illustrating an example of a learning process according to embodiments.

FIG. 4 is a diagram illustrating a configuration example of an unmanned vehicle system according to embodiments.

### DESCRIPTION OF EMBODIMENTS

Embodiments according to the present invention will be described in detail below based on the drawings. It should be noted that the present invention is not limited by the embodiments. The constituent elements in the following embodiments include those easily replaceable by those skilled in the art or those substantially identical. Furthermore, the constituent elements described below can be combined as appropriate, and two or more embodiments, if any, can be combined.

### EMBODIMENTS

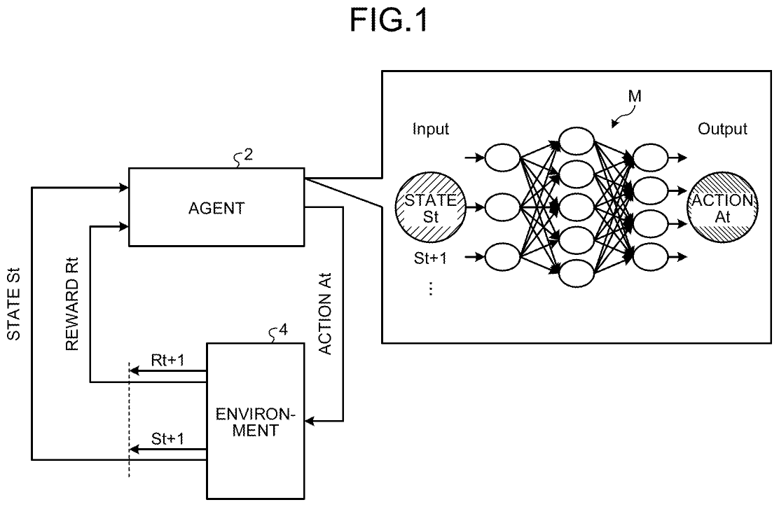

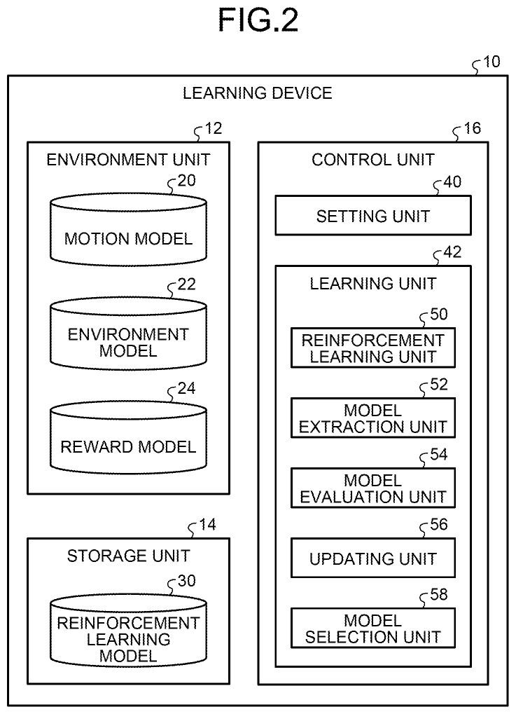

A learning device 10 and a learning method according to the present embodiment are a device and a method for allowing a learning model including hyperparameters to learn. FIG. 1 is an illustration of learning using a learning model according to the present embodiment. FIG. 2 is a block diagram illustrating a configuration example of a learning device according to the present embodiment.

Learning Using Learning Model

First of all, referring to FIG. 1, learning using a learning model M will be described. The learning model N is installed in an agent 2 that performs an action Aₜ. For example, a machine capable of performing operation, such as robot, vehicle, ship, or aircraft, is applicable as the agent 2. The agent 2 performs a predetermined action Aₜ under a predetermined environment 4 using the learning model M.

As illustrated in FIG. 1, the learning model M is a neural network having a plurality of nodes. The neural network is a network having a plurality of nodes connected to each other and has a plurality of lavers each including a plurality of nodes. The parameters of the neural network include weights and biases between nodes. Other parameters of the neural network include hyperparameters such as the number of layers of a hierarchy, the number of nodes, and the learning rate. In the present embodiment, the weights and the biases between nodes of the learning model M are learned.

Learning using the learning model M will now be described. Learning includes imitation learning and reinforcement learning. Imitation learning is supervised learning, in which the hyperparameters of the learning model M are learned so that the agent 2 performs a predetermined action Aₜ when a predetermined state Sₜ is input under a predetermined environment 4. Reinforcement learning is unsupervised learning, in which the hyperparameters of the learning model N are learned so that a reward Rₜ given to the agent 2 under a predetermined environment 4 is maximized.

In reinforcement learning, the agent 2 acquires a state Sₜ from the environment 4 and acquires a reward Rₜ from the environment 4. The agent 2 then selects an action Aₜ from the learning model M based on the acquired state Sₜ and reward Rₜ. When the agent 2 performs the selected action Aₜ, the state Sₜ of the agent 2 makes a transition to a state Sₜ₊₁ in the environment 4. In addition, the agent 2 is given a reward Rₜ₊₁ based on the performed action Aₜ, the state Sₜ before the transition, and the state S_{tα1} after the transition. In reinforcement learning, the above learning is repeated for an evaluable predetermined number of steps so that the reward Rₜ given to the agent 2 is maximized.

In the present disclosure, the learning device 10 learns a learning model to be installed in a computer in order to appropriately set the performance requirement of the communication device of an unmanned vehicle. The information transfer rate is determined for the communication device of an unmanned vehicle, and reinforcement learning for the determined information transfer rate is performed. When the learning device 10 determines that first performance requirement is satisfied for the determined information transfer rate, the information transfer rate is slowed down, and reinforcement learning is performed to satisfy second performance requirement.

In the present disclosure, the unmanned vehicle may be any unmanned vehicle. Examples of the unmanned vehicle include aircrafts, ships, and vehicles.

Learning Device

The description returns to FIG. 2. As illustrated in FIG. 2, the learning device 10 includes an environment unit 12, a storage unit 14, and a control unit 16.

The environment unit 12 provides an environment for performing reinforcement learning for a learned model. The environment unit 12 includes a motion model 20, an environment model 22, and a reward model 24. The environment unit 12 provides an environment for performing reinforcement learning, based on the motion model 20, the environment model 22, and the reward model 24.

Specifically, the environment unit 12 gives a reward to the learned model and derives a state of the learned model that changes with an action.

The storage unit 14 is a memory that stores various information. The storage unit 14 stores, for example, information such as computations of the control unit 16 and computer programs. The storage unit 14 includes, for example, at least one of a random access memory (RAM), a main storage device such as a read-only memory (ROM), and an external storage device such as a hard disk drive (HDD). The storage unit 14 stores a reinforcement learning model 30.

The reinforcement learning model 30 includes a plurality of learned models in reinforcement learning. The reinforcement learning model 30, for example, stores a plurality of learned models learned at each learning step.

The control unit 16 controls the operation of each unit of the learning device 10. The control unit 16 is implemented by, for example, a central processing unit (CPU) or a micro processing unit (MPU) executing a computer program stored in the storage unit 14 or the like using the RAM or the like as a work area. The control unit 16 may be implemented by an integrated circuit such as an application-specific integrated circuit (ASIC) or a field programmable gate array (FPGA). The control unit 16 may be implemented by a combination of hardware and software.

The control unit 16 includes a setting unit 40 and a learning unit 42.

The setting unit 40 sets various conditions for performing reinforcement learning. The setting unit 40 sets, for example, a first requirement value for a predetermined parameter of the communication device. The setting unit 40 sets, for example, action decision model (state and action), reward function, deep reinforcement learning algorithm, model granularity, and hyperparameters. In other words, the setting unit 40 constructs an environment for performing reinforcement learning. The details of the setting unit 40 will be described later.

The learning unit 42 performs learning of a learning model. The learning unit 42 includes a reinforcement learning unit 50, a model extraction unit 52, a model evaluation unit 54, an updating unit 56, and a model selection unit 58.

The reinforcement learning unit 50 performs learning based on rewards given by the environment unit 12. The details of the reinforcement learning unit 50 will be described later.

The model extraction unit 52 extracts, as a learned model, a learning model in which the number of learning steps of reinforcement learning by the reinforcement learning unit 50 is equal to or greater than a predetermined number. The details of the model extraction unit 52 will be described later.

The model evaluation unit 54 evaluates the learned model. The model evaluation unit 54 determines, for example, whether the performance of the learned model extracted by the model extraction unit 52 has reached first performance requirement. The details of the model evaluation unit 54 will be described later.

The updating unit 56 updates a requirement value set for a predetermined parameter of the communication device. For example, when the model evaluation unit 54 determines that the performance of the learned model has reached first performance requirement, the updating unit 56 updates the first requirement value to a second requirement value different from the first requirement value. The details of the updating unit 56 will be described later.

The model selection unit 58 selects a learned model to be installed in the communication device. The details of the model selection unit 58 will be described later.

Learning Process

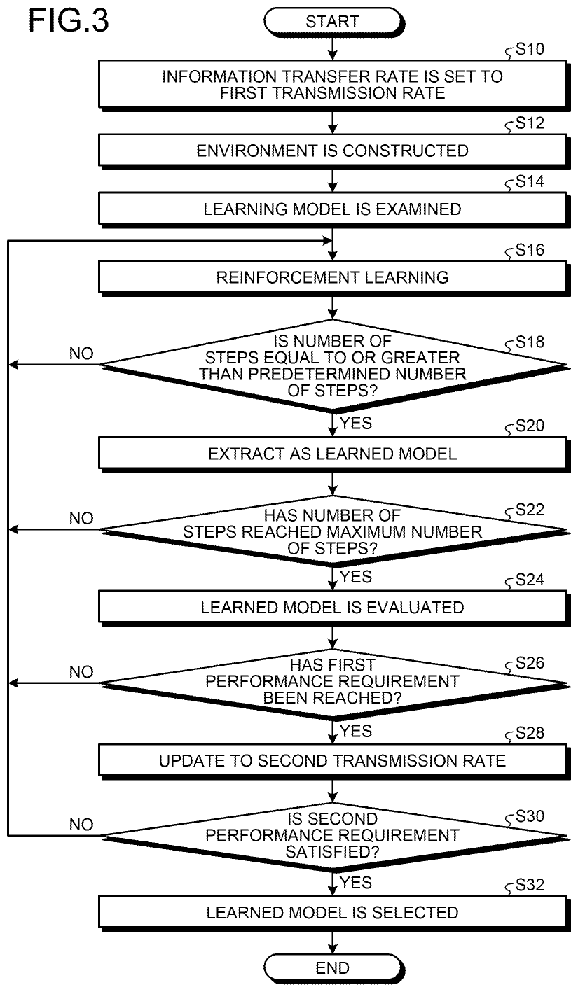

Referring to FIG. 3, the learning process according to the present embodiment will be described. FIG. 3 is a flowchart illustrating an example of the learning process according to the present embodiment. In the following, the process of learning the transmission rate of the information transfer rate of the communication device mounted on the unmanned vehicle will be described as an example, but the present disclosure is not limited thereto.

The setting unit 40 sets the information transfer rate of the communication device of the unmanned vehicle to a first transmission rate (step S10). Specifically, the setting unit 40 sets the first transmission rate that can be said to be sufficiently high as the information transfer rate set for the communication device. The first transmission rate is a kind of the first requirement value. The process then proceeds to step S12.

The setting unit 40 constructs various environments for performing reinforcement learning (step S12). Specifically, the setting unit 40 constructs, for example, a simulation environment for performing reinforcement learning. The process then proceeds to step

The setting unit 40 examines a learning model to perform reinforcement learning (step S14). Specifically, the setting unit 40 makes various examinations necessary for carrying out reinforcement learning, for example, examines action decision model (state and action), reward function, deep reinforcement learning algorithm, model granularity, and hyperparameters. The process then proceeds to step S16.

The reinforcement learning unit 50 performs reinforcement learning (step S16). Specifically, the reinforcement learning unit 50, for example, performs learning so that the reward given to the learned model is maximized. The process then proceeds to step S18.

The reinforcement learning unit 50 determines whether the number of steps of performing reinforcement learning is equal to or greater than a predetermined number of steps (step S18). The predetermined number of steps may be set as desired, for example, according to the problem to be handled. If it is determined that the number of steps is equal to or greater than a predetermined number of steps (Yes at step S18), the process proceeds to step S20. If it is determined that the number of steps is not equal to or greater than a predetermined number of steps (No at step S18), the process proceeds to step S16. In other words, in the present embodiment, reinforcement learning is repeated until a predetermined number of steps is reached.

If the determination is Yes at step S18, the model extraction unit 52 extracts a learned model (step S20). Specifically, the model extraction unit 52 extracts all learned models that have been subjected to reinforcement learning for a predetermined number of steps or more. The process then proceeds to step S22.

The reinforcement learning unit 50 determines whether the number of steps of performing reinforcement learning has reached the maximum number of steps (step S22). The maximum number of steps may be set as desired. If it is determined that the number of steps has reached the maximum number of steps (Yes at step S22), the process proceeds to step S24. If it is not determined that the number of steps has reached the maximum number of steps (No at step S22), the process proceeds to step S16. In other words, in the present embodiment, reinforcement learning is repeated until the number of learning steps has reached the maximum number of steps.

If the determination is Yes at step S22, the model evaluation unit 54 evaluates the performance of the learned model in which the number of steps has reached the maximum number of steps (step S24). The process then proceeds to step S26.

The model evaluation unit 54 determines whether the performance of the learned model has reached the first performance requirement (step S26). Specifically, the model evaluation unit 54 determines, for example, whether the learned model set to the first transmission rate set at step S10 has reached the desired first performance requirement. If it is determined that the performance of the learned model has reached the first performance requirement (Yes at step S26), the process proceeds to step S28. If it is not determined that the performance of the learned model has reached the first performance requirement (No at step S26), the process proceeds to step S16. In other words, in the present embodiment, reinforcement learning is repeated until it is determined that the performance of the learned model has reached the first performance requirement.

The updating unit 56 updates the first transmission rate set at step S10 to a second transmission rate (step S28). Specifically, the updating unit 56 updates the transmission rate to a second transmission rate lower than the first transmission rate. The second transmission rate is a kind of the second requirement value. The process then proceeds to step S30.

The model evaluation unit 54 determines whether the learned model updated from the first transmission rate to the second transmission rate satisfies the desired second performance requirement (step S30). The second performance requirement may be the same performance as the first performance requirement or may be inferior to the first performance requirement. The second performance requirement may be changed as desired in accordance with the design. For example, the second performance requirement may be changed in accordance with the function to be added to the communication device of the unmanned vehicle. If it is determined that the learned model updated to the second transmission rate satisfies the desired second performance requirement (Yes at step S30), the process proceeds to step S32. If it is not determined that the learned model updated to the second transmission rate satisfies the desired second performance requirement (No at step S30), the process proceeds to step S16. In other words, in the present embodiment, reinforcement learning is repeated until it is determined that the performance of the learned model satisfies the second performance requirement.

If the determination is Yes at step S30, the model selection unit 58 selects a learned model (step S32). Specifically, the model selection unit 58 selects the learned model determined to satisfy the second performance requirement at step S30 as the learned model to be installed in the computer of the unmanned vehicle. The process in FIG. 3 then ends.

In the present embodiment, the learned model selected by the learning device 10 is applied to the design of an unmanned vehicle having a communication device, whereby an unmanned vehicle system with a rate lower than the conventional system can be applied. Specifically, the present embodiment can provide an unmanned vehicle system in which the unmanned vehicles can cooperate even in a low-rate communication environment. In other words, in the present embodiment, learning is performed in a high-rate state and thereafter learning is carried out at a lower rate, whereby the data rate required by the unmanned vehicle system can be appropriately set.

Unmanned Vehicle System

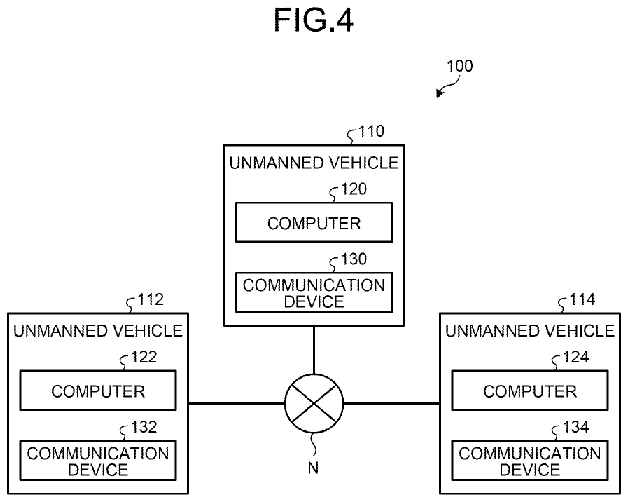

Referring to FIG. 4, a configuration example of the unmanned vehicle system according to embodiments will be described. FIG. 4 is a diagram illustrating a configuration example of the unmanned vehicle system according to embodiments.

As illustrated in FIG. 4, an unmanned vehicle system 100 includes an unmanned vehicle 110, an unmanned vehicle 112, and an unmanned vehicle 114. Unmanned vehicles 110 to 114 are, for example, but not limited to, vehicles, ships, or aircrafts. In the example illustrated in FIG. 4, the unmanned vehicle system 100 includes three unmanned vehicles, but the present disclosure is not limited thereto.

The unmanned vehicle 110 includes a computer 120 and a communication device 130. The unmanned vehicle 112 includes a computer 122 and a communication device 132. The unmanned vehicle 114 includes a computer 124 and a communication device 134. The communication device 130, the communication device 132, and the communication device 134 are communicatively connected via a wireless network N. The network N is, for example, but not limited to, a TDMA network.

The computers 120 to 124 are equipped with, for example, a learned model that satisfies the second performance requirement as selected by the learning device 10 in the process illustrated in FIG. 3. The computers 120 to 124 each include, for example, a processing unit such as a CPU and a storage device such as a RAM or a ROM. The computers 120 to 124 exchange information with other unmanned vehicles through the communication devices 130 to 134, for example, using a learned model that satisfies the second performance requirement. In other words, in the present embodiment, the computers 120 to 124 are equipped with, for example, a learned model, and the computers 120 to 124 communicate through the communication devices using the learned model, whereby the feasibility of the unmanned vehicle system is increased even with a low rate, and performance improvement that is difficult to achieve only with conventional wireless communication designs can be achieved.

The unmanned vehicles 110 to 114 transmit and receive information on each individual unmanned vehicle, using the computers 120 to 124 and the communication devices 130 to 134, respectively. In the present embodiment, the computers 120 to 124 use the learned model selected by the learning device 10 and exchange information with other unmanned vehicles through the communication devices to transmit and receive information on each individual unmanned vehicle at a low rate. This configuration creates a surplus in the resources of the wireless communication line. In other words, the unmanned vehicle system 100 in the present embodiment can create a surplus in the resources of the wireless communication line and thereby can expand functions, for example, extend the effective communication range, ensure function enhancement in the future, improve encryption strength, and reduce the weight and the power consumption of the communication device, and prevent interference with other stations.

A learning device, a communication device, an unmanned vehicle, a wireless communication system, a learning method, and a learning program described in the present embodiment are understood, for example, as follows.

A learning device according to a first aspect is a learning device for allowing a learned model to be installed in a communication device to learn. The learning device includes: a setting unit 40 configured to set a first requirement value for a predetermined parameter of the communication device controlled by a computer using the learned model; a reinforcement learning unit 50 configured to allow a learning model to learn such that a reward given in a predetermined environment is maximized; a model extraction unit 52 configured to extract, as a learned model, the learning model in which a number of learning steps is equal to or greater than a predetermined number; a model evaluation unit 54 configured to determine whether performance of the learned model extracted by the model extraction unit 52 has reached first performance requirement; an updating unit 56 configured to update the first requirement value to a second requirement value different from the first requirement value when the model evaluation unit 54 determines that performance of the learned model has reached the first performance requirement; and a model selection unit 58 configured to select a learned model to be installed in the computer. The model evaluation unit 54 determines whether performance of the learned model updated to the second requirement value satisfies second performance requirement different from the first performance requirement. When the model evaluation unit 54 determines that performance of the learned model updated to the second requirement value satisfies the second performance requirement, the model selection unit 58 selects a learned model that satisfies the second performance requirement as the learned model to be installed in the computer. With this configuration, the learning device according to the first aspect can appropriately select a learned model that satisfies the performance requirement that makes the unmanned vehicle system feasible and can achieve performance improvement that is difficult to achieve only with conventional wireless communication designs.

According to a second aspect, the updating unit 56 changes the second requirement value in accordance with the second performance requirement. With this configuration, the learning device according to the second aspect can set the performance requirement that makes the unmanned vehicle system feasible, as desired.

According to a third aspect, the predetermined parameter of the communication device is information transfer rate. The setting unit sets a first transmission rate as the first requirement value for the information transfer rate. The updating unit updates the first transmission rate to a second transmission rate lower than the first transmission rate. With this configuration, even when the information transfer rate is low, the learning device according to the third aspect can appropriately select a learned model that satisfies the performance requirement.

According to a fourth aspect, a communication device performs communication based on control using the learned model learned by the learning device according to any one of the first to third aspects. With this configuration, the communication device can reserve a surplus in the resources of the wireless communication line by slowing down the information transfer rate.

An unmanned vehicle according to a fifth aspect includes a computer 120 equipped with the learned model learned by the learning device according to any one of the first to third aspects, and a communication device 130. The computer 120 performs communication through the communication device 130 using the learned model. With this configuration, the communication device can reserve a surplus in the resources of the wireless communication line by slowing down the information transfer rate. The unmanned vehicle according to the fifth aspect can transmit information on the unmanned vehicle itself to other vehicles at a lower rate.

A wireless communication system according to a sixth aspect includes a plurality of unmanned vehicles 110 according to the fifth aspect. With this configuration, in the unmanned vehicle system according to the sixth aspect, the unmanned vehicles can cooperate even in a communication environment with a low information transfer rate.

A learning method according to a seventh aspect is a learning method for allowing a learned model to be installed in a computer to learn. The learning method includes: setting a first requirement value for a predetermined parameter of a communication device controlled by the computer using the learned model; allowing a learning model to learn such that a reward given in a predetermined environment is maximized; extracting, as a learned model, the learning model in which a number of learning steps is equal to or greater than a predetermined number; determining whether performance of the extracted learned model has reached first performance requirement; updating the first requirement value to a second requirement value different from the first requirement value when performance of the learned model is determined to have reached the first performance requirement; determining whether performance of the learned model updated to the second requirement value satisfies second performance requirement different from the first performance requirement; and selecting the learned model that satisfies the second performance requirement as the learned model to be installed in the computer when performance of the learned model updated to the second requirement value is determined to satisfy the second performance requirement. With this configuration, the learning method according to the seventh aspect can appropriately select a learned model that satisfies the performance requirement that makes the unmanned vehicle system feasible and can achieve performance improvement that is difficult to achieve only with conventional wireless communication designs.

A learning program according to an eighth aspect is a learning program for allowing a learned model to be installed in a computer to learn using a learning device. The learning program causes the learning device to perform: setting a first requirement value for a predetermined parameter of a communication device controlled by the computer using the learned model; allowing a learning model to learn such that a reward given in a predetermined environment is maximized; extracting, as a learned model, the learning model in which a number of learning steps is equal to or greater than a predetermined number; determining whether performance of the extracted learned model has reached first performance requirement; updating the first requirement value to a second requirement value different from the first requirement value when it is determined that performance of the learned model has reached the first performance requirement; determining whether performance of the learned model updated to the second requirement value satisfies second performance requirement different from the first performance requirement; and selecting the learned model that satisfies the second performance requirement as the learned model to be installed in the computer when performance of the learned model updated to the second requirement value is determined to satisfy the second performance requirement. With this configuration, the learning device according to the eighth aspect can appropriately select a learned model that satisfies the performance requirement that makes the unmanned vehicle system feasible and can achieve performance improvement that is difficult to achieve only with conventional wireless communication designs. The learning device may include a computer including at least a processor and a memory; the learning program may be stored on a (non-transitory) computer-readable storage medium, such as a magnetic disk, an optical disc, or a semiconductor memory, to be executed by the learning device which serves as that computer or the other computer in which the learned model is to be installed.

Although the embodiments of the present invention have been described above, the embodiments are not limited thereto. The constituent elements described above encompass a constituent element that is easily conceivable by those skilled in the art, substantially the same constituent element, and what is called an equivalent. The constituent elements described above can be appropriately combined with each other. Furthermore, some of the constituent elements can be variously omitted, substituted, or modified without departing from the spirit and scope of the embodiments described above.

### REFERENCE SIGNS LIST

10 Learning device
12 Environment unit
14 Storage unit
16 Control unit
20 Motion model
22 Environment model
24 Reward model
30 Reinforcement learning model
40 Setting unit
42 Learning unit
50 Reinforcement learning unit
52 Model extraction unit
54 Model evaluation unit
56 Updating unit
58 Model selection unit

1. A learning device for allowing a learned model to be installed in a computer to learn, the learning device comprising:
a setting unit configured to set a first requirement value for a predetermined parameter of a communication device controlled by the computer using the learned model;
a reinforcement learning unit configured to allow a learning model to learn such that a reward given in a predetermined environment is maximized;
a model extraction unit configured to extract, as a learned model, the learning model in which a number of learning steps is equal to or greater than a predetermined number;
a model evaluation unit configured to determine whether performance of the learned model extracted by the model extraction unit has reached first performance requirement;
an updating unit configured to update the first requirement value to a second requirement value different from the first requirement value when the model evaluation unit determines that performance of the learned model has reached the first performance requirement; and
a model selection unit configured to select the learned model to be installed in the computer, wherein
the model evaluation unit determines whether performance of the learned model updated to the second requirement value satisfies second performance requirement different from the first performance requirement, and
when the model evaluation unit determines that performance of the learned model updated to the second requirement value satisfies the second performance requirement, the model selection unit selects the learned model that satisfies the second performance requirement as the learned model to be installed in the computer.

2. The learning device according to claim 1, wherein the updating unit changes the second requirement value in accordance with the second performance requirement.

3. The learning device according to claim 1, wherein
the predetermined parameter of the communication device is information transfer rate,
the setting unit sets a first transmission rate as the first requirement value for the information transfer rate, and
the updating unit updates the first transmission rate to a second transmission rate lower than the first transmission rate.

4. A communication device configured to perform communication based on control using the learned model learned by the learning device according to claim 1.

5. An unmanned vehicle comprising:
a computer in which the learned model learned by the learning device according to claim 1 is installed; and
a communication device, wherein
the computer performs communication through the communication device using the learned model.

6. A wireless communication system comprising a plurality of unmanned vehicles each corresponding to the unmanned vehicle according to claim 5.

7. A learning method for allowing a learned model to be installed in a computer to learn, the learning method comprising:
setting a first requirement value for a predetermined parameter of a communication device controlled by the computer using the learned model;
allowing a learning model to learn such that a reward given in a predetermined environment is maximized;
extracting, as a learned model, the learning model in which a number of learning steps is equal to or greater than a predetermined number;
determining whether performance of the extracted learned model has reached first performance requirement;
updating the first requirement value to a second requirement value different from the first requirement value when performance of the learned model is determined to have reached the first performance requirement;
determining whether performance of the learned model updated to the second requirement value satisfies second performance requirement different from the first performance requirement; and
selecting the learned model that satisfies the second performance requirement as the learned model to be installed in the computer when performance of the learned model updated to the second requirement value is determined to satisfy the second performance requirement.

8. A non-transitory computer-readable storage medium storing a learning program for allowing a learned model to be installed in a computer to learn using a learning device serving as another computer, the learning program causing the learning device to perform:
setting a first requirement value for a predetermined parameter of a communication device controlled by the computer using the learned model;
allowing a learning model to learn such that a reward given in a predetermined environment is maximized;
extracting, as a learned model, the learning model in which a number of learning steps is equal to or greater than a predetermined number;
determining whether performance of the extracted learned model has reached first performance requirement;
updating the first requirement value to a second requirement value different from the first requirement value when performance of the learned model is determined to have reached the first performance requirement;
determining whether performance of the learned model updated to the second requirement value satisfies second performance requirement different from the first performance requirement; and
selecting the learned model that satisfies the second performance requirement as the learned model to be installed in the computer when performance of the learned model updated to the second requirement value is determined to satisfy the second performance requirement.
